(19) United States
(12) Patent Application Publication
(10) Pub. No.: US 2007/0289802 A1
(43) Pub. Date: Dec. 20, 2007

(54) Recessed control panel

(75) Inventors: Kyle Thomas Ressler, West Bend, WI (US); Lawrence W. Lange, Beaver Dam, WI (US); Robert J. Loehr, Kewaskum, WI (US)

Correspondence Address: DEERE & COMPANY, ONE JOHN DEERE PLACE, MOLINE, IL, 61265, US

(73) Assignee: Deere & Company, a Delaware Corporation.

(21) Appl. No.: 11/455,420

(22) Filed: Jun. 19, 2006

(51) Int. Cl. B60K 13/00; B62D 25/14

(52) U.S. Cl. 180/335; 180/90

(57) ABSTRACT

A recessed control panel for a grass mowing machine includes a panel mounted in a recess in a top surface of a side cover on the grass mowing machine. Several controls are attached to panel. The panel has a lower forward end and a higher rearward end, is hinged at the lower forward end, and is releasably secured at the higher rearward end. A throttle lever extends less than one inch above the top surface of the side cover while the throttle is in a full position.

### FIELD OF THE INVENTION

This invention relates to controls for grass mowing machines, and specifically to panels for mounting controls used to operate the machine.

### BACKGROUND OF THE INVENTION

Grass mowing machines typically have several controls for the operator including a throttle lever, choke, PTO on/off switch, light switch and/or other accessory switches or buttons. The controls may be positioned on a control panel at or near the operator seat or operator station of the grass mowing machine, and preferably are located conveniently for the operator to reach easily while mowing.

Controls on grass mowing machines often are damaged when operating the machine near trees, shrubs, fences, etc. Obstructions tend to catch on controls such as a throttle knob, and damage or move the controls away from their intended settings. A control panel for a grass mowing machine is needed that can reduce or eliminate damage or unintended movement of controls caused by obstructions.

It may be necessary to make repairs or adjustments to the controls, components, wiring harnesses and/or mechanical connections behind the control panel of a grass mowing machine. A control panel is needed that can provide easy access to service items behind the panel.

### SUMMARY OF THE INVENTION

A recessed control panel is provided for a grass mowing machine. The control panel is recessed to reduce or eliminate damage or unintended movement of controls due to obstructions. The control panel can easily open to provide easy access to service items behind the panel.

### BRIEF DESCRIPTION OF THE DRAWINGS

FIG. 1 is a perspective view, partially in section, of a recessed control panel in a side cover on a grass mowing machine, according to a first embodiment of the invention.

FIG. 2 is a side section view of a recessed control panel with a throttle lever in a full or high position, according to a first embodiment.

FIG. 3 is a side section view of a recessed control panel with a throttle lever in a low position, according to a first embodiment.

FIG. 4 is a top perspective view of a rear portion of a grass mowing machine having a recessed control panel, according to a first embodiment.

### DESCRIPTION OF THE PREFERRED EMBODIMENT

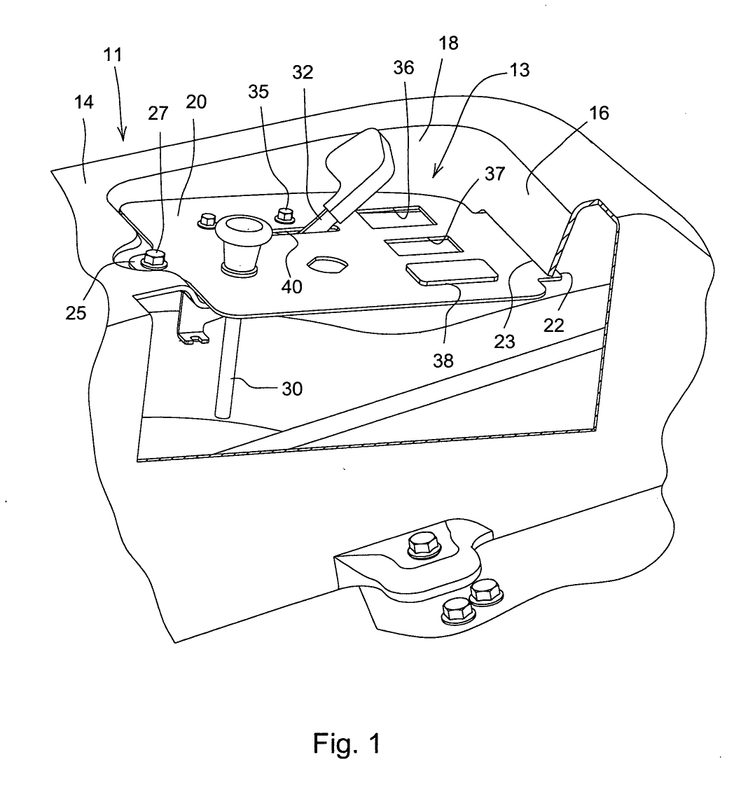

As shown in FIGS. 1-4, the recessed control panel of the present invention may be on a grass mowing machine 10 having side covers 11, 12 adjacent and to each side of the operator station of the machine. The recessed control panel may be mounted in a side cover so that the controls may be positioned conveniently for the operator to reach; i.e., near the resting position of an operator's hand, on either the left or right side of the machine.

In one embodiment, each side cover may be a plastic or sheet metal body part having a top surface 14. Depending on the machine configuration, the side cover may have one or more other surfaces that may cover various components of the machine such as tires and wheels, fuel tanks, engine cooling system components, or serve other functions. Recess 13 may be an opening formed, molded or cut into the top surface 14 of side cover 11. Control panel 20 may be mounted in recess 13.

In one embodiment, recess 13 may include front wall 16 and a pair of side walls 18. Front wall 16 of recess 13 may be at a forward end of the recess, and may have a depth of between about 1½ inches and about 4 inches from the top surface 14 of side cover 11.

In one embodiment, control panel 20 may be a generally flat plastic or metal surface, with a plurality of slots, recesses or openings for controls that may be attached to and/or extend through the panel. These controls may include throttle lever 32, choke control 30, hour meter 36, PTO switch 37, light switch 38, and other controls if desired. At least some of the controls, such as the hour meter, PTO switch and light switch, may be mounted in and/or attached to the control panel slots so that the controls are completely below top surface 14 of side cover 11 during any operational mode or switch state of the control.

In one embodiment, control panel 20 may be positioned in recess 13 such that a forward end of the panel is lower than a rearward end of the panel. For example, the slope of the panel mounted in the recess may be between about 5 degrees and about 20 degrees from horizontal. The slope provides a means of draining moisture off the panel.

In one embodiment, control panel 20 may be mounted in recess 13 such that the panel can swing open to provide access to connections and components under the panel for servicing. For example, the lower forward end of panel 20 may be hinged to the lower end of the front wall. In the embodiment shown in FIGS. 1-4, the forward end of panel 20 may be hinged to the front wall by inserting tab 22, at the lower forward end of the panel, into slot 23, at or near the lower end of the front wall. The dimensions of tab 22 may be sufficiently less than the dimensions of slot 23 so that the tab can be easily inserted and removed from the slot, and also to allow panel 20 to pivot upwardly and swing open to provide service access under the panel while the tab remains in the slot. As a result, the tab and slot can provide a hinged joint for the panel to swing open and provide access to items under the panel for servicing, without requiring additional parts or fasteners.

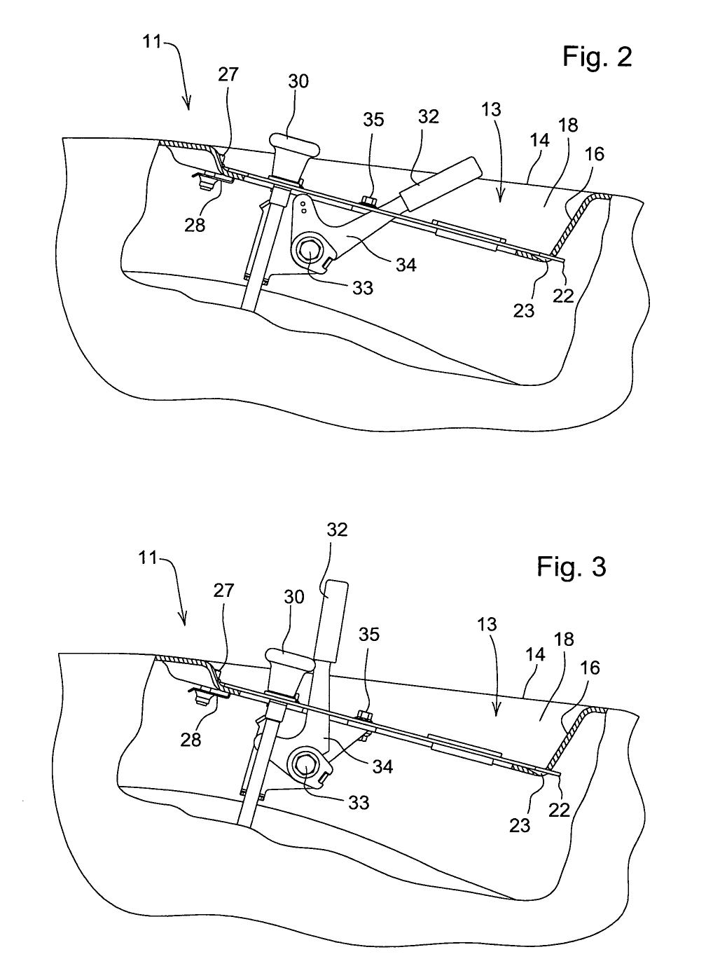

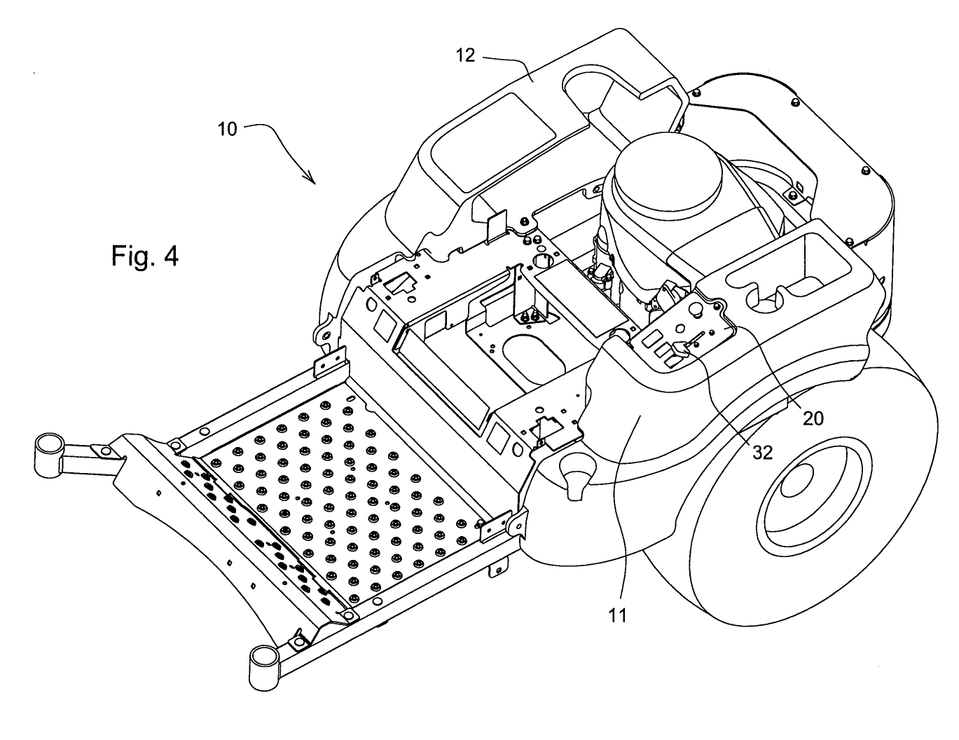

In one embodiment, panel 20 may be releasably secured to the side cover with only one fastener. As shown in FIGS. 2 and 3, hold down bolt 27 is the only fastener used to secure the panel to the side cover. The second or upper end of panel 20 may be releasably secured to side cover 11 with hold down bolt 27. The hold down bolt may be inserted through projection 25 at the second end of the panel and tightened onto clip 28. The hold down bolt is the only fastener that may be engaged to secure the panel and disengaged to allow the panel to pivot upwardly and swing open.

In one embodiment, throttle linkage 34 may be mounted to control panel 20. Preferably, when the panel is mounted to the recess and the throttle is in the full or high position, no part of throttle lever 32 extends more than about one inch above top surface 14 of side cover 11. FIG. 2 shows throttle lever 32 in the full or high position which is typically the position of the throttle while mowing. Throttle linkage 34 may be fastened to the underside of the control panel with attachment bolts 35. Throttle lever may extend through slot 40 and be connected to throttle pivot 33 in the throttle linkage 34.

As shown in FIG. 3, if the throttle is in the low position, throttle lever 32 extends further above top surface 14 of side cover 11 than when the throttle is in full or high position. For example, in the low position, at least part of the throttle lever may extend more than about one inch above the top surface 14 of side cover 11. The throttle lever can extend further above the side cover in the low position because many grass mowing machines typically are not used for mowing with the throttle in the low position.

Having described the preferred embodiment, it will become apparent that various modifications can be made without departing from the scope of the invention as defined in the accompanying claims.

1. A recessed control panel for a grass mowing machine, comprising:
a panel mounted in a recess in a top surface of a side cover on the grass mowing machine;
a plurality of controls attached to panel;
wherein the panel has a lower forward end and a higher rearward end, is hinged at the lower forward end, and is releasably secured at the higher rearward end.

2. The recessed control panel of claim 1 further comprising a throttle lever extending less than one inch above the top surface of the side cover while the throttle is in a full position.

3. The recessed control panel of claim 1 wherein the lower forward end includes a tab that is insertable into a slot in the recess.

4. The recessed control panel of claim 1 further comprising a throttle linkage attached to the control panel.

5. The recessed control panel of claim 1 wherein at least some of the controls attached to the panel are below the top surface of the side cover in all operating states.

6. A recessed control panel for a grass mowing machine, comprising:
a sloped panel mounted in a recess in a side cover and having a top surface;
a plurality of controls attached to the control panel;
wherein the panel is attached to the recess by a single fastener that is removable to swing the panel up to provide service access under the panel.

7. The recessed control panel of claim 6 wherein the panel is hinged to the side cover.

8. The recessed control panel of claim 6 further comprising a pivoting throttle control that extends through the panel.

9. The recessed control panel of claim 8 wherein the pivoting throttle control extends less than one inch above the top surface of the side cover in a full position.

10. The recessed control panel of claim 9 wherein the pivoting throttle control extends further above the top surface of the side cover in a low position than in the full position.

11. The recessed control panel of claim 6 wherein at least some of the controls remain completely below the top surface of the side cover in all operating states.

12. A recessed control panel for a grass mowing machine, comprising:
a panel mounted in a recess in a top surface of a side cover of a mower, the panel having a plurality of controls attached thereto and extending therethrough including a throttle control that pivots between a low position and a full position, the throttle control extending less than one inch above the top surface in the full position.

13. The recessed control panel of claim 12 wherein the panel has a lower forward end and a higher rearward end.

14. The recessed control panel of claim 12 wherein the panel is hinged to the side cover.

15. The recessed control panel of claim 12 wherein the panel is releasably secured to the side cover with a single fastener.

16. The recessed control panel of claim 12 wherein at least one of the controls remains below the top surface of the side cover in all operating states.

17. The recessed control panel of claim 12 further comprising a tab on the panel insertable into a slot in the recess.
